(19) United States
(12) Patent Application Publication
(10) Pub. No.: US 2026/0259438 A1
(43) Pub. Date: Sep. 3, 2026

(54) OPTICAL MODULATOR AND OPTICAL TRANSMISSION APPARATUS USING THE SAME

(71) Applicant: SUMITOMO OSAKA CEMENT CO., LTD., Tokyo (JP)

(72) Inventors: Hideki ICHIMEI, Tokyo (JP); Makoto SHIMADA, Tokyo (JP)

(73) Assignee: SUMITOMO OSAKA CEMENT CO., LTD., Tokyo (JP)

(21) Appl. No.: 18/876,158

(22) PCT Filed: Jun. 30, 2023
(86) PCT No.: PCT/JP2023/024360

§ 371 Date: Dec. 17, 2024

(51) Int. Cl. G02F 1/035

(52) U.S. Cl. CPC G02F 1/0356

(57) ABSTRACT

An object of the present invention is to provide an optical modulator in which, even in a case where an electronic circuit element, such as a driver circuit, and a wiring substrate are disposed close to each other, short-circuiting of a wiring or the like of the wiring substrate is suppressed. The present invention relates to an optical modulator including an optical modulation element, an electronic circuit element 4 that inputs a high-frequency signal to the optical modulation element, and a case 1 that accommodates the optical modulation element and the electronic circuit element 4, in which the electronic circuit element 4 is adhesively fixed on a surface of a block 40 fixed to one surface of the case 1, the surface of the block 40 being opposite to the one surface of the case 1, the optical modulator further includes a wiring substrate 3 (3′) that is disposed adjacent to the electronic circuit element 4 and is fixed to the one surface of the case 1 and that includes a wiring electrically connected to the electronic circuit element 4 on a surface of the wiring substrate 3 (3′) opposite to the one surface of the case 1, and a height (h1) from the one surface of the case 1 to the surface of the block 40 on which the electronic circuit element is adhesively fixed and a height (h2) from the one surface of the case 1 to the surface of the wiring substrate 3 (3′) on which the wiring of the wiring substrate 3 (3′) is provided are different from each other.

### TECHNICAL FIELD

The present invention relates to an optical modulator and an optical transmission apparatus using the same, and particularly relates to an optical modulator that includes an optical modulation element, an electronic circuit element that inputs a high-frequency signal to the optical modulation element, and a case that accommodates the optical modulation element and the electronic circuit element, and an optical transmission apparatus using the same.

### BACKGROUND ART

There has been a demand for providing an optical modulator that can be driven at a high frequency and with a low drive voltage and that can be further miniaturized by incorporating an optical modulation element and an electronic circuit element, such as a driver circuit that drives the optical modulation element, together into a case, as in a high bandwidth coherent driver modulator (HB-CDM) in recent years.

FIG. 1 is an example of an optical modulator incorporating a driver circuit, in which an optical modulation element 5 is disposed within a case 1. The optical modulation element includes an optical waveguide made of a material having an electro-optic effect, a modulation electrode that applies an electric field to the optical waveguide to modulate a light wave propagating through the optical waveguide, and the like.

The light wave to be input to the optical modulation element 5 is introduced into the case 1 by an input collimator 9 connected to an optical fiber FB, and is input to the optical modulation element 5 via an optical block 8, a lens 7, or the like. In addition, the light wave modulated by the optical modulation element 5 is led out to an outside of the case 1 through the optical block 8, which includes the lens 7 and an optical multiplexing/demultiplexing unit, and is input to the optical fiber FB by an output collimator 10.

Meanwhile, for a modulation signal to be input to the optical modulation element 5, a modulation signal generated outside the case 1 is introduced into the case, and is supplied to a driver circuit 4 through a wiring of an input substrate 2. The modulation signal is amplified by the driver circuit 4, then supplied to the modulation electrode of the optical modulation element 5, and finally introduced into a termination substrate 6.

The driver circuit is supplied with direct current (DC) power for driving the driver circuit. The DC power supplied from a DC power source outside the case 1 is supplied to the driver circuit 4 through a wiring substrate 3 (or 3′) in the case.

FIG. 2 is a cross-sectional view taken along an alternate long and short dash line A-A′ of FIG. 1. Normally, the case 1 in FIG. 2 includes a lid (not shown) that covers an upper side of the drawing, but the lid is not shown here. The driver circuit 4 is bonded to a block 40 fixed to an inner surface of the case 1. Since heat generated from the driver circuit 4 also affects an operation of the optical modulation element, it is necessary to release the heat to the outside of the case. Therefore, the block 40 is made of a material with high thermal conductivity and operates as a heat sink. Further, a material with high thermal conductivity and electrical conductivity, for example, an Ag filler or solder paste or the like is used as an adhesive for bonding the driver circuit 4 and the block 40. In addition, Patent Literature No. 1 proposes using the optical modulation element as one of radiation means for an electronic component.

Meanwhile, a wiring is exposed on a surface of the wiring substrate 3 (3′) (a surface opposite to a surface of the wiring substrate fixed to the case 1), and an electrode pad portion (portion to be wire-bonded) of the wiring and a terminal of the driver circuit 4 are bonded with a wire (not shown) made of Au or the like.

However, the driver circuit 4 and the wiring substrate 3 (3′) are disposed close to each other, and a joint surface between the driver circuit 4 and the block 40 and a height of the surface of the wiring substrate 3 are configured to be substantially the same. Therefore, when the driver circuit 4 is bonded, an adhesive AD may protrude from the joint surface and come into contact with the wiring substrate 3, causing a risk of short-circuiting of the wiring disposed on the surface of the wiring substrate. One method of solving this problem is to increase a clearance between the driver circuit 4 and the wiring substrate 3, but this method gives rise to a new problem in that the optical modulator cannot be sufficiently miniaturized.

### CITATION LIST

### Patent Literature

[Patent Literature No. 1] Japanese Laid-open Patent Publication No. 2019-207362
[Patent Literature No. 2] Japanese Laid-open Patent Publication No. 2017-134241
[Patent Literature No. 3] Japanese Laid-open Patent Publication No. 2022-144126
[Patent Literature No. 4] International Publication No. WO2023/053406A1

### SUMMARY OF INVENTION

### Technical Problem

An object to be achieved by the present invention is to solve the above-mentioned problems and to provide an optical modulator in which, even in a case where an electronic circuit element, such as a driver circuit, and a wiring substrate are disposed close to each other, short-circuiting of a wiring or the like of the wiring substrate is suppressed. In addition, another object is to provide an optical transmission apparatus using the optical modulator.

### Solution to Problem

In order to solve the above-described problems, an optical modulator and an optical transmission apparatus using the same according to the present invention have the following technical features.
(1) An optical modulator including an optical modulation element, an electronic circuit element that inputs a high-frequency signal to the optical modulation element, and a case that accommodates the optical modulation element and the electronic circuit element, in which the electronic circuit element is adhesively fixed on a surface of a block fixed to one surface of the case, the surface of the block being opposite to the one surface of the case, the optical modulator further includes a wiring substrate that is disposed adjacent to the electronic circuit element and is fixed to the one surface of the case and that includes a wiring electrically connected to the electronic circuit element on a surface of the wiring substrate opposite to the one surface of the case, and a height (h1) from the one surface of the case to the surface of the block on which the electronic circuit element is adhesively fixed and a height (h2) from the one surface of the case to the surface of the wiring substrate on which the wiring of the wiring substrate is provided are different from each other.
(2) The optical modulator according to (1) described above, in which the height (h1) of the block is greater than the height (h2) of the wiring substrate.
(3) The optical modulator according to (1) described above, in which a difference between the height (h1) of the block and the height (h2) of the wiring substrate is 0.2 mm or higher.
(4) The optical modulator according to (1) described above, in which at least a part of a periphery of the surface of the block on which the electronic circuit element is joined is chamfered.
(5) The optical modulator according to (1) described above, in which an adhesive for bonding the electronic circuit element to the block is electrically conductive.
(6) The optical modulator according to (1) described above, in which the optical modulation element and an input substrate that supplies a high-frequency signal to the electronic circuit element are disposed to sandwich the electronic circuit element, and the input substrate, the electronic circuit element, and the optical modulation element are disposed and fixed in the case such that a wiring position at which the input substrate and the electronic circuit element are connected and a wiring position at which the electronic circuit element and the optical modulation element are connected are located on the same plane.
(7) An optical transmission apparatus including the optical modulator according to any one of (1) to (6) described above, and a data creation unit that supplies a high-frequency signal to the optical modulator.

It is needless to say that the present invention is not limited to the above-described contents, and that the technical features according to (2) to (6) described above can be combined as necessary, for example.

### Advantageous Effects of Invention

According to the present invention, an optical modulator includes an optical modulation element, an electronic circuit element that inputs a high-frequency signal to the optical modulation element, and a case that accommodates the optical modulation element and the electronic circuit element, in which the electronic circuit element is adhesively fixed on a surface of a block fixed to one surface of the case, the surface of the block being opposite to the one surface of the case, the optical modulator further includes a wiring substrate that is disposed adjacent to the electronic circuit element and is fixed to the one surface of the case and that includes a wiring electrically connected to the electronic circuit element on a surface of the wiring substrate opposite to the one surface of the case, and a height (h1) from the one surface of the case to the surface of the block on which the electronic circuit element is adhesively fixed and a height (h2) from the one surface of the case to the surface of the wiring substrate on which the wiring of the wiring substrate is provided are different from each other. Therefore, it is possible to provide an optical modulator in which, even in a case where the electronic circuit element, such as a driver circuit, and the wiring substrate are disposed close to each other, short-circuiting of the wiring or the like of the wiring substrate is suppressed even when an adhesive protrudes from a joint portion between the electronic circuit element and the block. In addition, it is possible to provide an optical transmission apparatus using the optical modulator that exhibits such an effect.

### BRIEF DESCRIPTION OF DRAWINGS

FIG. 1 is a plan view showing an example of an optical modulator.

FIG. 2 is a cross-sectional view taken along an alternate long and short dash line A-A′ of FIG. 1.

FIG. 3 is a cross-sectional view of an optical modulator according to the present invention as in FIG. 2.

FIG. 4 is another cross-sectional view of the optical modulator according to the present invention as in FIG. 2.

FIG. 5 is a diagram (part 1) illustrating a process of attaching an electronic circuit element to the optical modulator.

FIG. 6 is a diagram (part 2) illustrating a process of attaching an electronic circuit element to the optical modulator.

FIG. 7 is a cross-sectional view taken along an alternate long and short dash line B-B′ of FIG. 1.

FIG. 8 is a diagram illustrating a block 40 used in the optical modulator according to the present invention.

FIG. 9 is a diagram illustrating an optical transmission apparatus in which a data creation unit is connected to the optical modulator according to the present invention.

FIG. 10 is another conceptual diagram of the optical transmission apparatus according to the present invention.

FIG. 11 is a diagram illustrating an application example of the optical transmission apparatus according to the present invention.

### DESCRIPTION OF EMBODIMENTS

Hereinafter, the present invention will be described in detail using preferred examples.

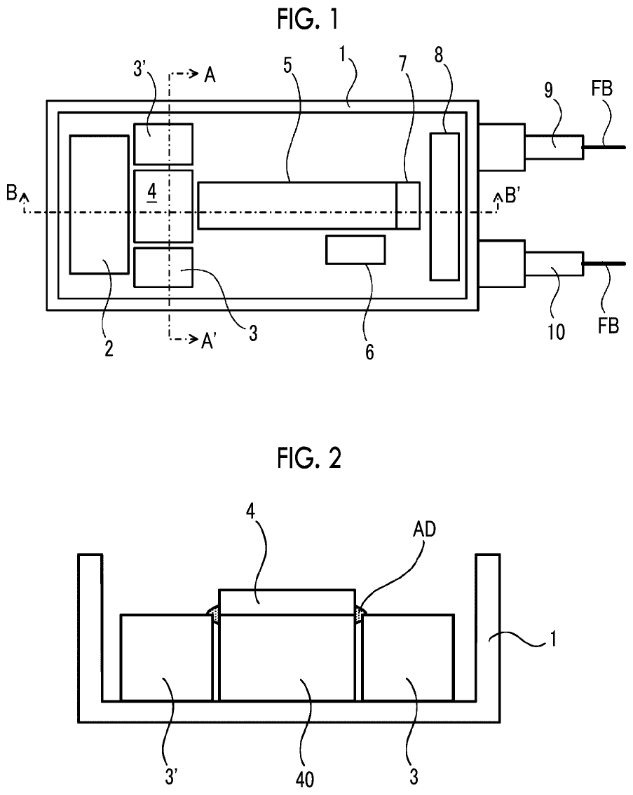

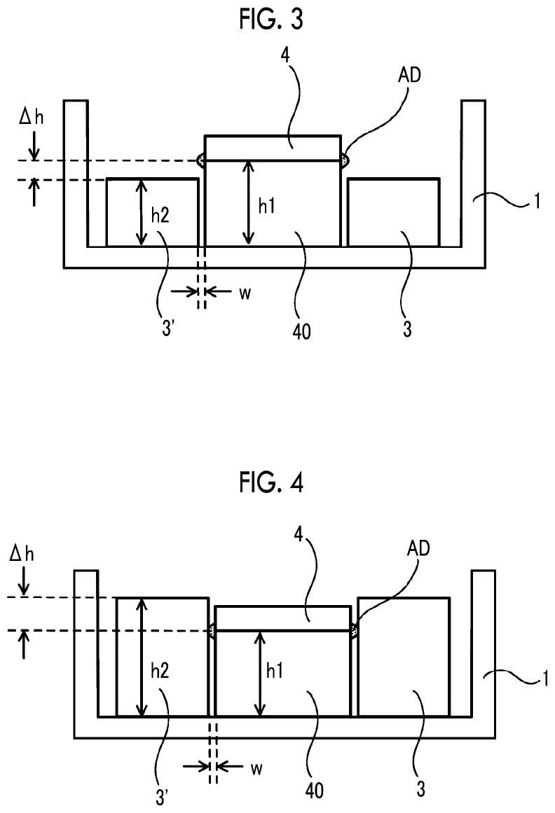

According to the present invention, as shown in FIGS. 3 and 4, there is provided an optical modulator including an optical modulation element, an electronic circuit element 4 that inputs a high-frequency signal to the optical modulation element, and a case 1 that accommodates the optical modulation element and the electronic circuit element 4, in which the electronic circuit element 4 is adhesively fixed on a surface of a block 40 fixed to one surface of the case 1, the surface of the block 40 being opposite to the one surface of the case 1, the optical modulator further includes a wiring substrate 3 (3′) that is disposed adjacent to the electronic circuit element 4 and is fixed to the one surface of the case 1 and that includes a wiring electrically connected to the electronic circuit element 4 on a surface of the wiring substrate 3 (3′) opposite to the one surface of the case 1, and a height (h1) from the one surface of the case 1 to the surface of the block 40 on which the electronic circuit element is adhesively fixed and a height (h2) from the one surface of the case 1 to the surface of the wiring substrate 3 (3′) on which the wiring of the wiring substrate 3 (3′) is provided are different from each other. FIGS. 3 and 4 are cross-sectional views taken along an alternate long and short dash line A-A′ of the optical modulator of FIG. 1 as in FIG. 2.

In the optical modulation element used in the optical modulator according to the present invention, as a material for forming an optical waveguide, various materials such as a substrate having an electro-optic effect, such as lithium niobate (LN), lithium tantalate (LT), and lead lanthanum zirconate titanate (PLZT), a vapor-phase growth film formed of these materials, a semiconductor material, and an organic material can be used.

In the optical modulation element, a modulation electrode is formed along the optical waveguide on a surface of a substrate on which the optical waveguide is formed, and a modulation signal, which is a high-frequency signal, is applied to the modulation electrode to modulate a light wave propagating through the optical waveguide. The substrate on which the optical waveguide is formed can be formed into a thin plate of about several μm, and can be formed into a composite substrate laminated with a holding substrate. In addition, a bias electrode to which a DC bias voltage is applied can be separately disposed, in addition to the modulation electrode.

For the case used in the optical modulator according to the present invention, a metal material with high thermal conductivity, such as SUS or Kovar, is selected in consideration of assembly processes such as cutting workability, laser welding, and sealing. In addition, a case surface (a lower surface of the case 1 in FIGS. 3 and 4) to which the block 40 and the like, which will be described below, are fixed can be made of a metal material, and a case side surface can be made of a ceramic material or a compound material in which ceramics are laminated. When the case side surface is formed of a ceramic material or a compound material of the ceramic material, the wiring substrate 3 (3′) or the input substrate 2, which will be described below, can be formed integrally with the case side surface.

In addition, although not shown in FIGS. 3 and 4, a lid formed of a metal material is provided on an upper surface side of the case 1, and the lid and an upper part of the case side surface are hermetically sealed by welding or the like.

The case surface to which the block 40 and the like are fixed in FIGS. 3 and 4 may be used as a bottom surface of an optical modulator main body, or as shown in Patent Literature No. 3, the case surface may be used as an upper surface of the optical modulator main body, and the case 1 in FIG. 3 or the like can be fixed to a printed circuit board (not shown) in an upside-down state.

As the electronic circuit element 4, a driver circuit for amplifying the modulation signal, a multiplexer (parallel/serial converter) disclosed in Patent Literature No. 4, or the like is used.

In order to dissipate heat generated from the electronic circuit element 4 to an outside of the case 1, the block 40 with high thermal conductivity is used, which Serves as a heat sink. For the block 40, a material with higher thermal conductivity than SUS or Kovar used for the case 1 is preferably used, and a composite material such as Cu—W, Cu—Mo, or Al—SiC is used.

As an adhesive for adhesively fixing the electronic circuit element 4 to the block 40, an adhesive having electrical conductivity and thermal conductivity, such as an Ag filler, is suitably used.

In addition, in a case where a metal surface is formed on a bonding surface of the electronic circuit element 4 by plating or the like, a solder paste can be used.

As shown in FIGS. 3 and 4, the optical modulator according to the present invention is characterized in that the height (h1) of the block 40 and the height (h2) of the wiring substrate 3 (3′) disposed close to the block are different from each other. In FIG. 3, a state of h1>h2 is shown, and even when an adhesive AD interposed between the electronic circuit element 4 and the block 40 protrudes from a side surface, the adhesive AD does not reach the wiring substrate 3 (3′). In addition, in FIG. 4, a state of h1<h2 is shown, and the protruding adhesive AD reaches a side surface of the wiring substrate 3 (3′). However, the wiring formed on the wiring substrate 3 (3′) is formed (exposed) on an upper surface of a substrate main body (an upper side surface of the wiring substrate 3 (3′) in FIG. 3 or 4), and no wiring is formed on the side surface of the substrate main body. Therefore, the wiring of the wiring substrate 3 (3′) does not short-circuit.

As shown in FIGS. 3 and 4, a difference Δh between the height h1 of the block 40 and the height h2 of the wiring substrate 3 (3′) is preferably 0.2 mm or higher, and more preferably in a range of 0.2 to 0.3 mm. In addition, taking into consideration of the miniaturization of the optical modulator and the amount of the protruding adhesive AD, it is preferable to a clearance between the block 40 and the wiring substrate 3 (3′) in a range of 0.1 to 0.2 mm.

The wiring substrate 3 (3′) is a wiring substrate that supplies power to the electronic circuit element 4 such as a driver circuit, and particularly supplies DC power. The DC power supplied from the DC power source outside the case 1 is introduced to the wiring substrate 3 (3′) through a DC pin or a flexible printed circuit board (FPC) disposed on an outer wall surface of the case 1, and further through a wiring extending inside the case. Further, an electrode pad portion (a terminal of the wiring formed on the upper surface of the substrate main body) of the wiring of the wiring substrate 3 (3′) and a terminal of the electronic circuit element 4 are bonded with a wire (not shown) made of Au or the like.

As in Patent Literature No. 3, in a case where the wiring substrate 3 (3′) and a side wall of the case 1 are integrally formed, the wiring substrate 3 (3′) and the side wall of the case 1 can be made of a ceramic material or a compound material in which ceramics are laminated. In this case, the FPC is connected to the terminal exposed to the outside of the side wall (or a part of a bottom surface) of the case 1, and wire bonding is performed to the wiring (electrode pad portion) exposed to the inside of the case 1 from a part of the side wall of the case that serves as the wiring substrate, so that a wiring for power supply can be easily provided.

The adhesive AD can be applied using a dispenser. Further, it is preferable to use a die bonder to thinly and uniformly spread the adhesive interposed between the electronic circuit element 4 and the block 40.

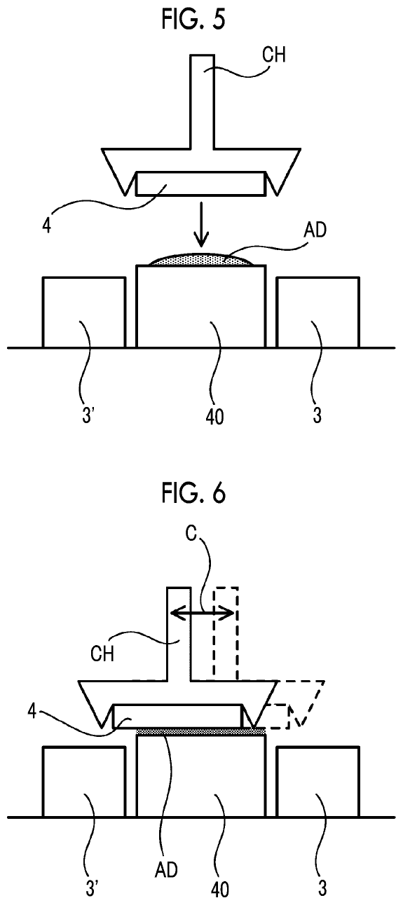

Specifically, as shown in FIG. 5, the adhesive AD is applied onto an upper surface of the block 40, and then the electronic circuit element 4 held by suction or the like using a chuck jig CH is pressed against the block 40. In this case, the electronic circuit element 4 is pressed against the upper surface of the block while applying a load, and as shown in FIG. 6, a scrubbing operation of moving the chuck jig CH in a direction parallel to the upper surface of the block 40 is performed, thereby making it possible to form a thin and uniform thickness of the adhesive.

In order to perform such a scrubbing operation, the electronic circuit element 4 moves parallel to the upper surface of the block 40, so that it is preferable that the wiring substrate 3 (3′) disposed in the vicinity of the block 40 is lower than the height of the block 40 (h1>h2).

As shown in Patent Literature No. 2 and Patent Literature No. 3, in order to suppress a propagation loss of the modulation signal, which is a high-frequency signal, for example, as shown in FIG. 1, it is preferable to locate the wiring positions connecting the input substrate 2, the electronic circuit element 4 such as a driver circuit, and the optical modulation element 5 disposed inside the case 1 of the optical modulator on the same plane. As shown in Patent Literature No. 2, it is preferable to dispose the optical modulation element 5 and the termination substrate 6 such that positions of upper surfaces of the optical modulation element 5 and the termination substrate 6 are located on the same plane.

The input substrate 2 is used to introduce a modulation signal generated by a data creation unit, such as a digital signal processor (DPS) disposed outside the optical modulator, into the case 1 and to supply the modulation signal to the electronic circuit element 4 such as a driver circuit. As shown in Patent Literature No. 2, the input substrate 2 can be formed integrally with the side wall of the case 1. A main body of the input substrate 2 is made of a ceramic material or a compound material of the ceramic material, and an electrical wiring is provided inside the main body or on a surface of the main body.

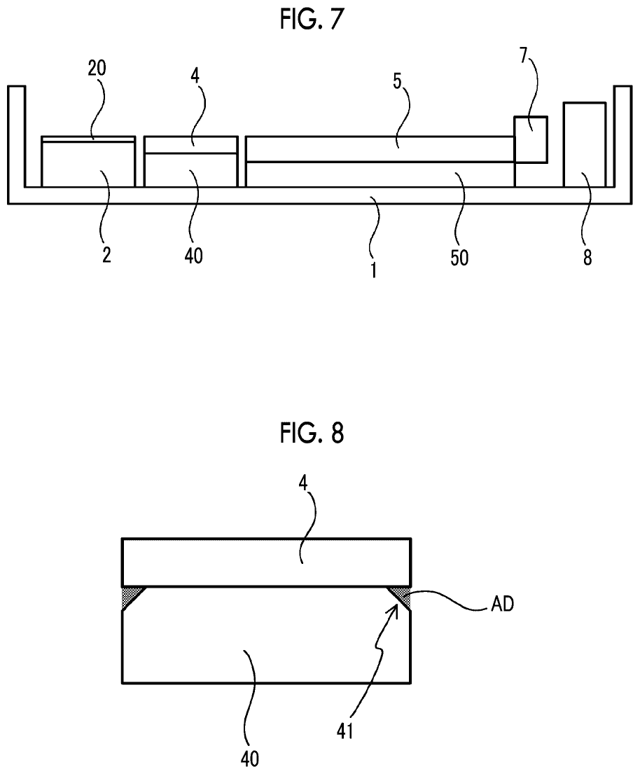

The “wiring substrate” in the optical modulator according to the present invention is a concept that encompasses the “input substrate”. In addition, the “wiring substrate” according to the present invention may also include the “optical modulation element”. FIG. 7 is a cross-sectional view taken along an alternate long and short dash line B-B′ of FIG. 1, in which a wiring 20 on the upper surface of the input substrate 2, the upper surface of the electronic circuit element 4 (a surface on which a connection terminal is disposed), and the upper surface of the optical modulation element (a surface on which the modulation electrode and the electrode pad portion (terminal) are disposed) are configured to be located on the same plane. A wiring for electrically connecting the members is not shown.

Though depending on a thickness of the electronic circuit element 4, for example, in a case where the thickness of the electronic circuit element 4 is 0.2 mm or higher, the position of the wiring 20 on the upper surface of the input substrate 2 or the position of the terminal of the modulation electrode on the upper surface of the optical modulation element is separated from the position of the bonding surface between the electronic circuit element 4 and the block 40 by 0.2 mm or higher. As a result, even though the adhesive protrudes, the adhesive does not cause short-circuiting of the wiring 20 on the upper surface of the input substrate 2 or the terminal of the modulation electrode.

In a case where the “input substrate” is included in the “wiring substrate” according to the present invention, the “height h2 of the wiring substrate” is a thickness of the input substrate, and in a case where the “optical modulation element” is included, the “height h2 of the wiring substrate” is a sum of a height of a pedestal 50 that supports the optical modulation element 5 and the thickness of the optical modulation element 5 (including an adhesive layer between the pedestal 50 and the optical modulation element 5, if any).

As shown in FIG. 7, in a case where the positions of the upper surfaces of the members are located on the same plane, the direction of the scrubbing operation performed when the electronic circuit element 4 is adhesively fixed to the block 40 is limited to only the direction in which the wiring substrate 3 (3′) is disposed. Therefore, it is preferable to set the height h2 of the wiring substrate 3 (3′) lower than the height hl of the block 40.

In order to suppress the amount of the adhesive AD that protrudes from the block 40, it is preferable to form a chamfered portion 41 on a part of a periphery of the upper surface of the block 40 as shown in FIG. 8. Thereby, the protruding adhesive AD is accommodated in the chamfered portion, and as a result, the amount of the adhesive protruding from the block 40 is reduced.

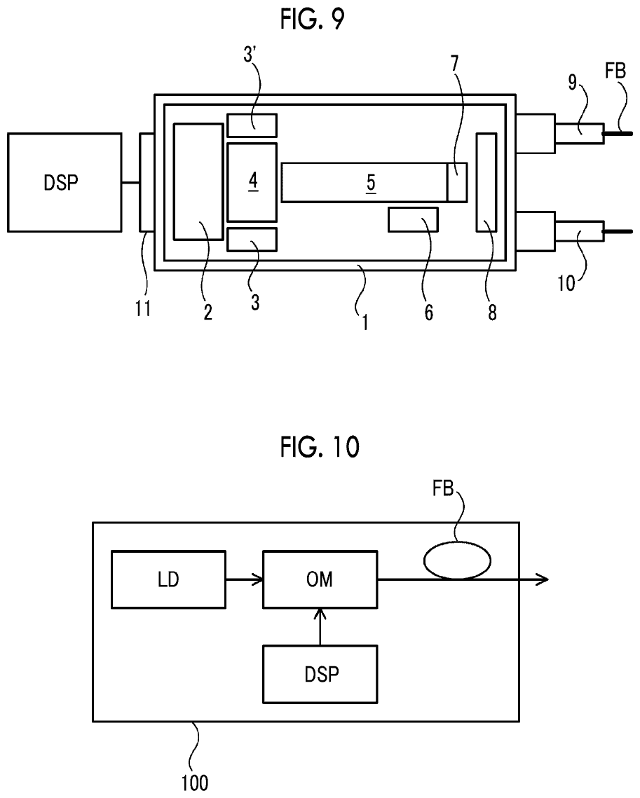

FIG. 9 shows an optical transmission apparatus in which a data creation unit (DSP) is connected to the optical modulator shown in FIG. 1. In addition, as shown in FIG. 10, it is possible to configure an optical transmission apparatus 100 such that a light source LD such as a semiconductor laser that generates a light wave to be input to an optical modulator OM, a data creation unit DSP that generates a modulation signal to be input to the optical modulator OM, and an optical fiber FB for leading out output light from the optical modulator OM are incorporated into a signal package.

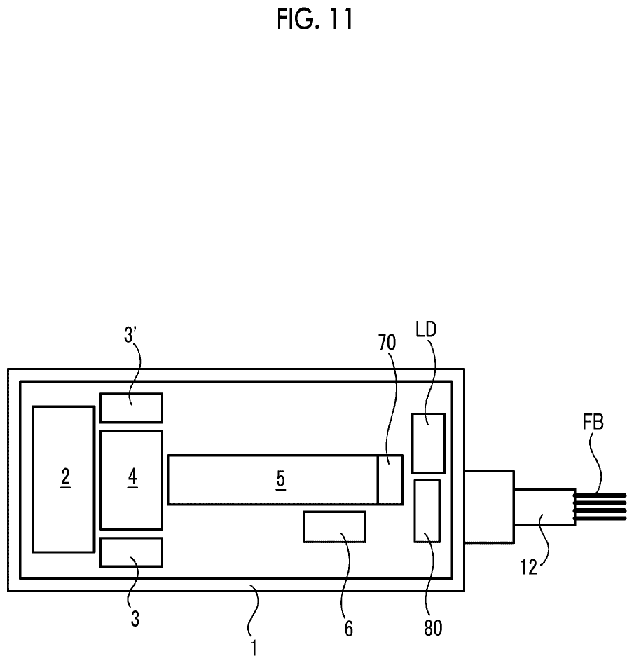

In FIG. 11, a light source LD such as a semiconductor laser can be incorporated into the case 1 of the optical modulator. In addition, in a case where the light waves output from the light source LD have a plurality of wavelengths, it is possible to separate the light waves generated from the light source for each wavelength and perform the modulation operation for each light wave. For the wavelength separation, it is possible to use a filter incorporated together with an optical component provided in the light source LD or a lens attached to an end portion of the optical modulation element, or the like. Reference numeral 80 is an optical block that performs polarization beam combining for each light wave and that derives the output light for each wavelength. A plurality of optical fibers corresponding to the respective wavelengths are connected to an output collimator 12.

In addition, in a case where a light source such as a semiconductor laser is mounted inside the case 1, it is necessary to ensure the connection between the block (pedestal) that supports a semiconductor laser element and the case 1, as with the block 40, so that heat generated from the light source can be sufficiently radiated to the outside.

### INDUSTRIAL APPLICABILITY

As described above, according to the present invention, it is possible to provide an optical modulator in which, even in a case where an electronic circuit element, such as a driver circuit, and a wiring substrate are disposed close to each other, short-circuiting of a wiring or the like of the wiring substrate is suppressed. In addition, it is possible to provide an optical transmission apparatus using the optical modulator having such an excellent effect.

### REFERENCE SIGNS LIST

1: case
2: input substrate (wiring substrate)
3, 3′: wiring substrate
4: electronic circuit element (such as a driver circuit)
5: optical modulation element
6: termination substrate
7: optical component such as lens
8: optical multiplexing/demultiplexing unit (optical block)
DSP: data creation unit (digital processing device)
LD: light source (semiconductor laser)
FB: optical fiber

1. An optical modulator comprising:
an optical modulation element;
an electronic circuit element that inputs a high-frequency signal to the optical modulation element; and
a case that accommodates the optical modulation element and the electronic circuit element,
wherein the electronic circuit element is adhesively fixed on a surface of a block fixed to one surface of the case, the surface of the block being opposite to the one surface of the case,
the optical modulator further includes a wiring substrate that is disposed adjacent to the electronic circuit element and is fixed to the one surface of the case and that includes a wiring electrically connected to the electronic circuit element on a surface of the wiring substrate opposite to the one surface of the case, and
a height (h1) from the one surface of the case to the surface of the block on which the electronic circuit element is adhesively fixed and a height (h2) from the one surface of the case to the surface of the wiring substrate on which the wiring of the wiring substrate is provided are different from each other.

2. The optical modulator according to claim 1,
wherein the height (h1) of the block is greater than the height (h2) of the wiring substrate.

3. The optical modulator according to claim 1,
wherein a difference between the height (h1) of the block and the height (h2) of the wiring substrate is 0.2 mm or higher.

4. The optical modulator according to claim 1,
wherein at least a part of a periphery of the surface of the block on which the electronic circuit element is joined is chamfered.

5. The optical modulator according to claim 1,
wherein an adhesive for bonding the electronic circuit element to the block is electrically conductive.

6. The optical modulator according to claim 1,
wherein the optical modulation element and an input substrate that supplies a high-frequency signal to the electronic circuit element are disposed to sandwich the electronic circuit element, and
the input substrate, the electronic circuit element, and the optical modulation element are disposed and fixed in the case such that a wiring position at which the input substrate and the electronic circuit element are connected and a wiring position at which the electronic circuit element and the optical modulation element are connected are located on the same plane.

7. An optical transmission apparatus comprising:
the optical modulator according to claim 1; and
a data creation unit that supplies a high-frequency signal to the optical modulator.
